(19) United States
(12) Patent Application Publication
(10) Pub. No.: US 2002/0037438 A1
(43) Pub. Date: Mar. 28, 2002

(54) Magnetic recording media and magnetic recording -reproducing apparatus using the same

(76) Inventor: Hiromichi Takami, Ome-shi (JP)

Correspondence Address: PILLSBURY WINTHROP LLP, 1600 TYSONS BOULEVARD, MCLEAN, VA, 22102, US

(21) Appl. No.: 09/941,572

(22) Filed: Aug. 30, 2001

(30) Foreign Application Priority Data
Sep. 19, 2000 (JP) 2000-283913

(51) Int. Cl. G11B 5/725

(52) U.S. Cl. 428/694 TF

(57) ABSTRACT

Disclosed is a magnetic recording media including a lubricating layer containing a lubricant and at least one antioxidant selected from the group consisting of a phenolic antioxidant and an amine-based antioxidant. The lubricating layer permits maintaining a good lubricity over a long period of time between a magnetic head and the surface of the magnetic recording media when the magnetic head performs the sliding contact with the surface of the magnetic recording media in the recording-reproducing stage.

### CROSS-REFERENCE TO RELATED APPLICATIONS

This application is based upon and claims the benefit of priority from the prior Japanese Patent Application No. 2000-283913, Sep. 19, 2000, the entire contents of which are incorporated herein by reference.

### BACKGROUND OF THE INVENTION

1. Field of the Invention

The present invention relates to a magnetic recording-reproducing apparatus and a magnetic recording media used in the magnetic recording-reproducing apparatus, particularly, to an improvement in the lubricating layer included in the magnetic recording media.

2. Description of the Related Art

Known is a contact recording type magnetic recording-reproducing apparatus in which a magnetic head is brought into contact with a magnetic disk when an information is recorded and reproduced.

The contact recording type magnetic disk comprises in general a magnetic layer formed on a substrate for performing a magnetic recording, a protective layer for protecting a magnetic recording media from, for example, a mechanical shock, and a lubricating layer for improving the lubricity when a magnetic head slides along a magnetic disk. A fluorine-based lubricant or the like is used for forming the lubricating layer.

However, the lubricant is decomposed or polymerized by the contact sliding between the magnetic head and the magnetic disk, giving rise to the problem that a highly viscous material is formed within the lubricant so as to lower the lubricity of the lubricant.

Also, during the contact sliding, electrons called exo-electrons are generated in the interface between the magnetic head and the magnetic disk. The exo-electrons are active and act on the lubricant molecule so as to generate radicals. Since the radicals thus generated are unstable, the decomposition and polymerization of the lubricant are further promoted so as to further lower the lubricity of the lubricant.

Under the circumstances, it has been made an attempt to suppress the decomposition and polymerization of the lubricant by adding various additives effective for lowering the friction and abrasion to the lubricant. For example, Jpn. Pat. Appln. KOKAI Publication No. 10-134332 discloses the technology of adding cyclotriphosphazane together with phosphorus or a nitrogen compound to the lubricant. However, it is impossible to suppress sufficiently the promotion of the decomposition and polymerization of the lubricant derived from the presence of the exo-electrons.

### BRIEF SUMMARY OF THE INVENTION

An object of the present invention is to provide a magnetic recording media capable of exhibiting a good lubricity for a long period of time relative to a magnetic head sliding along the surface of the magnetic recording media.

According to a first aspect of the present invention, there is provided a magnetic recording media, comprising a substrate and a laminated layer formed on the substrate, the laminate layer includes a magnetic layer, and a lubricating layer, and the lubricating layer contains a lubricant and at least one antioxidant selected from the group consisting of a phenolic antioxidant and an amine-based antioxidant.

Further, according to a second aspect of the present invention, there is provided a magnetic recording-reproducing apparatus, comprising:

a magnetic recording media;

a driving mechanism for supporting and rotating the magnetic recording media;

a magnetic head including a recording element recording information in the magnetic recording media and an element reproducing the information recorded in the magnetic recording media; and

a carriage assembly supporting the magnetic head such that the supported magnetic head is movable relative to the magnetic recording media;

in which the magnetic recording media comprises a substrate and a laminated layer formed on the substrate, the laminated layer having a magnetic layer, and a lubricating layer, and the lubricating layer containing a lubricant and at least one antioxidant of a phenolic antioxidant and an amine-based antioxidant.

According to the present invention, the contact recording type magnetic recording-reproducing can be performed while maintaining good lubricity between the magnetic head and the surface of the magnetic recording media for a long period of time.

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention, and together with the general description given above and the detailed description of the embodiments given below, serve to explain the principles of the present invention.

FIG. 1 is a cross sectional view exemplifying a magnetic recording media of the present invention; and

FIG. 2 is an oblique view exemplifying a magnetic recording-reproducing apparatus of the present invention.

### DETAILED DESCRIPTION OF THE INVENTION

A magnetic recording media according to a first embodiment of the present invention comprises a substrate and a laminated layers formed on the substrate, including a magnetic layer, a protective layer and a lubricating layer, and the lubricating layer contains a lubricant and at least one antioxidant of a phenolic antioxidant and an amine-based antioxidant.

A magnetic recording-reproducing apparatus according to a second embodiment of the present invention, comprising:

the magnetic recording media described above;

a driving mechanism for supporting and rotating the magnetic recording media;

a magnetic head including a recording element recording to record information in the magnetic recording media and a reproduce element to reproduce the information recorded in the magnetic recording media; and

a carriage assembly supporting the magnetic head such that the supported magnetic head is movable relative to the magnetic recording media.

It is desirable for the magnetic recording-reproducing apparatus to which is applied the magnetic recording media of the present invention to be of a contact recording type, in which the magnetic head is in contact with the magnetic disk in recording-reproducing information, or of a CCS (Contact-Start-Stop) type, in which the magnetic head floats in the recording-reproducing stage and the magnetic head is in contact with the magnetic disk when the magnetic disk is not rotated.

In each of the two types noted above, the contact sliding is achieved between the magnetic disk and the magnetic head. Specifically, in the contact recording type, the magnetic head is always kept in the sliding contact with magnetic disk in the recording-reproducing stage. When it comes to the CSS type, the sliding contact is achieved between the magnetic head and the magnetic disk during the period between the time when the rotation of the magnetic disk is started and the time when the magnetic head bigins to floats and during the period between the time when the rotation of the magnetic disk is lowered so as to allow the magnetic head to begin to contact the magnetic disk and the time when the rotation of the magnetic disk is stopped.

According to the present invention, at least one antioxidant of a phenolic antioxidant and an amine-based antioxidant is added to a lubricant layer. As a result, the antioxidant reacts with the lubricant converted to be a radical. In this reaction, the lubricant is brought back to the original state, and the antioxidant is converted to be a radical. Since the radical generated from the antioxidant is stable, the generated radical is unlikely to react with another molecule so as to suppress the decomposition and polymerization of the lubricant.

The antioxidant used in the present invention is selected from the group consisting of a phenolic antioxidant and an amine-based antioxidant.

The phenolic antioxidants and the amine-based antioxidants used in the present invention include, for example, 1,3,5-trimethyl-2,4,6-tris (3,5-di-t-butyl-4-hydroxybenzyl) benzene, 1,6-hexanediol-bis (3-(3,5-di-t-butyl-4-hydroxyphenyl) propionate), 2-(2′-hydroxy-5′-t-octylphenyl) benzotriazole, 2-(3,5-di-t-amyl-2-hydroxyphenyl) benzotriazole, 2-(3,5-di-t-butyl-2-hydoxyphenyl)-5-chlorobenzo triazole, 2-(3,5-di-t-butyl-2-hydroxyphenyl) benzotriazole, 2-(3,5-di-t-butyl-4-hydroxybenzyl)-2-n-butyl malonic acid bis (1,2,2,6,6-pentamethyl-4-pyridyl), 2-(3-t-butyl-5-methyl-2-hydroxyphenyl)-5-chlorobenzo triazole, 2,2′-methylene bis (4-methyl-6-t-butyl phenol), 2-(2-hydoxy-3-(3,4,5,6-tetrahydrophthalimide methyl)-5-methyl phenyl) benzotriazole, 2-(2-hydroxy-3,5-bis (α, α-dimethyl benzyl) phenyl)-2H-benzotriazole, 2-(1-(2-hydroxy-3,5-t-pentyl phenyl) ethyl)-4,6-d-t-pentylphenyl acrylate, addition product between 2-t-butyl-4-hydroxy benzene and dicyclopentadiene, 2-t-butyl-6-(3-t-butyl-2-hydroxy-5-methyl benzyl)-4-methylphenyl acrylate, 3,9-bis (2-(3-(3-t-butyl-4-hydroxy-5-methyl phenyl) propionyloxy)-1,1-dimethyl ethyl)-2,4,8,10-tetraoxa spiro (5,5) undecane, 4,4-butylidene bis-(6-t-butyl-3-methyl phenol), 4,4′-methylene bis (2,6-di-t-butyl phenol), 5,7-di-t-butyl-3-(3,4-dimethyl phenyl)-3H-benzofuran-2-on, a condensate of N,N′-bis (3-aminopropyl) ethylenediamine and 2,4-bis (N-butyl-N-1,2,2,6,6-pentamethyl-4-pyridyl) amino)6-chloro-1,3,5 triazine, N,N′-hexamethylene bis (3,5-di-t-butyl-4-hydroxy-hydrocyanamide), n-octadecyl-3-(4-hydroxy-3′,5′-di-t-butyl phenyl) propionate, isooctyl-3-(3,5-di-t-butyl-4-hydroxy phenyl) propionate, octadecyl-3-(3,5-di-t-butyl-4-hydroxy phenyl) propionate, di-stearyl-3,5-di-t-butyl-4-hydroxybenzyl phosphonate, tetrakis (methylene-3-(3′,5′-di-t-butyl-4(-hydroxy phenyl) propionate) methane, triethylene glycol bis (3-(3,5-di-t-butyl-4-hydroxy phenyl) propionate), triethylene glycose bis (3-(3-t-butyl-5-methyl-4-hydroxy phenyl) propionate), bis (1,2,2,6,6-pentamethyl-4-piperidinyl) sebacate, bis (2,2,6,6-tetramethyl-4-piperizyl) sebacate, pentaerythritol tetrakis (3-(3,5-di-t-butyl-4-hydroxy phenyl) propionate), poly{(6-(1,1,3,3-tetramethyl butyl) amino-1,3,5-triazine-2,4-diyl){(2,2,6,6-tetramethyl-4-piperidyl) imino} hexamethylene {(2,2,6,6-tetramethyl-4-piperidyl) imino}}, methyl-3-(3-t-butyl-5-(2H-benzotriazole-2-yl)-4-hydroxy phenyl) propionate-polyethylene glycol condensate, 2-(2′-hydroxy-5′-t-octyl phenyl) benzotriazole, 2-(3,5-di-t-butyl-2-hydroxy phenyl)-5-chlorobenzo triazole, 2-(3,5-di-t-butyl-2-hydroxy phenyl) benzotriazole, 2-(3,5-di-t-butyl-4-hydroxybenzyl)-2-n-butyl malonic acid bis (1,2,2,6,6-pentamethyl-4-piperidyl), 2-(3-t-butyl-5-methyl-2-hydroxy phenyl)-5-chlorobenzo triazole, 2-(2-hydroxy-3-(3,4,5,6-tetrahydrophthalimide-methyl)-5-methyl phenyl) benzotriazole, 2-(2-hydroxy-3,5-bis (α, α-dimethyl benzyl) phenyl)-2H-benzotriazole, 2-mercaptobenzo imidazole, zinc salt of 2-mercaptobenzo imidazole, 2-mercaptomethyl benzoimidazole, N-(3′-hydroxy butylidene)-1-naphtylmine, a condensate of N,N′-bis(3-aminopropyl) ethylene diamine and 2,4-bis (N-butyl-N-(1,2,2,6,6-pentamethyl-4-piperidyl) amino)-6-chloro-1,3,5-triazine, N,N′-di-β-naphthyl-P-phenylene diamine, N,N′-diphenyl-P-phenylene diamine, N-phenyl-N′-isopropyl-P-phenylene diamine, N-phenyl-β-naphthyl amine, a polycondensate of dimethyl succinate and 1-(2-hydroxymethyl)-4-hydroxy-2,2,6,6-tetramethyl piperidine, phenyl-a-naphthyl amine, poly{(6-(1,1,3,3-tetramethyl butyl) amino-1,3,5-triazine-2,4-diyl)((2,2,6,6,-tetramethyl-4-piperidyl) imino) hexamethylene ((2,2,6,6-tetramethyl-4-piperidyl) imino)}, and a condensate of methyl-3-{3-t-butyl-5-(2H-benzotriazole-2-yl)-4-hydroxy phenyl} propionate and polyethylene glycol.

It is possible to add a compound other than the phenolic antioxidant and the amine-based antioxidant to the lubricant in the present invention.

It is desirable that a content of the antioxidant in the lubricating layer is 0.05 to 10% by weight. If the content of the antioxidant in the lubricating layer is smaller than 0.05% by weight, the antioxidant fails to produce its effect sufficiently. On the other hand, if the content of the antioxidant exceeds 10% by weight, the lubricity of the lubricating layer tends to be impaired. More preferably, the content of the antioxidant maybe of 0.1 to 5% by weight.

It is preferred for the lubricating layer to contain a fluorine-based lubricant and at least one of the maleic anhydride modified polybutene represented by chemical formula (1) given below:

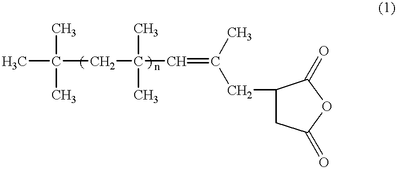

It is preferred to use at least one kind of the fluorine-containing lubricant selected from the group consisting of Fomblin Z, Fomblin Y, Krytox, Demnum and derivatives thereof having modified terminal groups.

The basic skeletal structures of these fluorine-containing lubricants are as follows:

Fomblin Z: —(CF₂CF₂O)ₘ(CF₂O)ₙ—

Fomblin Y: —(CF(CF₃)CF₂O)ₘ—(CF₂O)ₙ—

Krytox: —(CF(CF₃)CF₂O)ₘ—

Demnum: —(CF₂CF₂CF₂O)ₘ—

Fluorine-containing lubricants having denatured terminal groups are available on the market. The terminal groups of these fluorine-containing lubricants include, for example, an OH group, a piperonyl group, a carboxyl group, and an isocyanate group.

In order to improve the compatibility between the additive and the lubricant, it is possible in the present invention to introduce an atomic group compatible with the lubricant into the chemical structure of the additive. By the introduction of the particular atomic group, it is possible to suppress the agglomeration of the additive.

For example, in the case of using Fomblin Zdol as the lubricant, it is possible to introduce a perfluoroalkyl group into the chemical structure of the additive.

It is also possible to use an addition reaction product between the additive and the lubricant.

Fomblin Zdol has a chemical structure (2) given below:

HO—C₂H₄O—(CF₂O)ₙ(C₂F₄O)ₘ—C₂H₄OH (2)

On the other hand, 1,3,5-trimethyl-2,4,6-tris (3,5-di-t-butyl-4-hydroxy benzyl) benzene used as an additive has a chemical structure (3) given below:

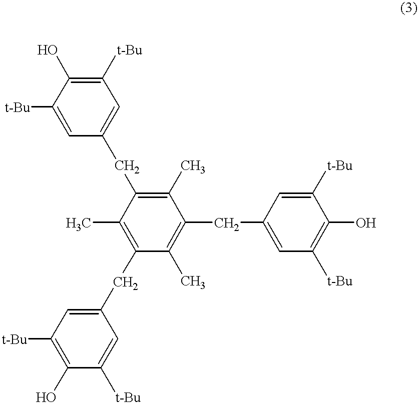

It is possible to obtain an addition product having a chemical structure (4) given below by the combination of the lubricant having the chemical structure (2) given above and the additive having the chemical structure (3) given above:

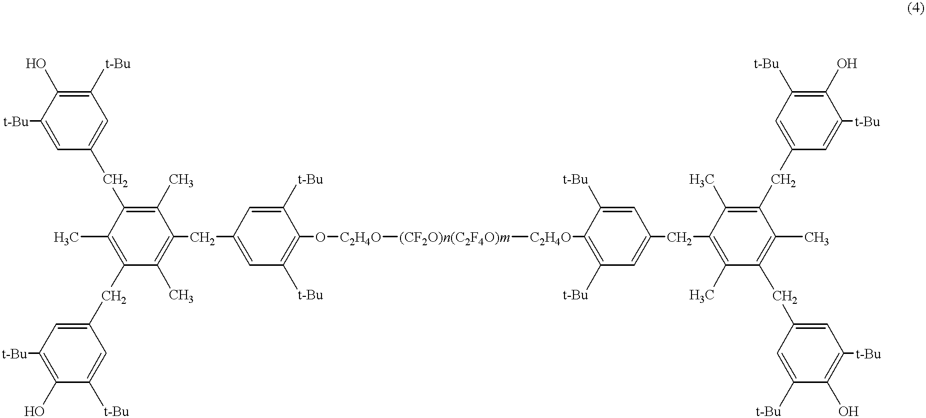

In the chemical structure (4) given above, the portion of 3,5-di-t-butyl-4-hydroxy benzyl represents the atomic group performing the function of the antioxidant and acting as an antioxidant in the present invention. In the addition product, two of the three functional groups are reserved.

The present invention will now be described more in detail with reference to the accompanying drawings.

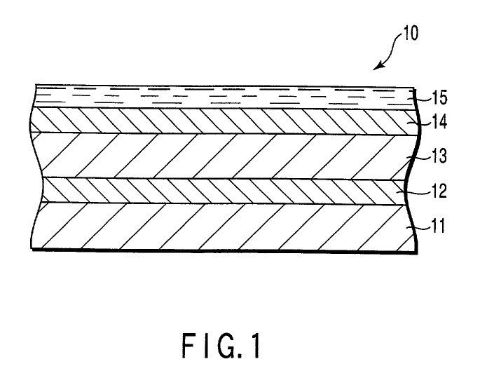

FIG. 1 is a cross sectional view schematically exemplifying the construction of a magnetic recording media 10 of the present invention. As shown in the drawing, the magnetic recording media 10 of the present invention comprises a substrate 11 and a laminate structure formed on the substrate 11 which includes an underlying layer 12, a magnetic layer 13, a protective layer 14 and a lubricating layer 15, are laminated in the order mentioned. The lubricating layer 15 contains an antioxidant selected from a phenolic antioxidant and an amine-based antioxidant. Also, the underlying layer 12 can be formed optionally.

The magnetic recording media 10 can be obtained by forming first the underlying layer 12, the magnetic layer 13 and the protective film 14 by a sputtering method in the order mentioned on the substrate 11, followed by forming the lubricating layer 6 on the protective layer 14 by a coating method.

In the present invention, the lubricating layer based on a lubricant containing additives can be prepared by, for example, a dip coating method or a spin coating method.

In the dip coating method, a lubricant coating solution is prepared by dissolving the lubricant and the additive in a suitable solvent, followed by dipping the disk in the resultant coating solution and subsequently pulling up the disk at a suitable speed. It is possible to control the thickness of the coated lubricant film by controlling the various conditions such as the dipping time, the pull-up speed and the concentrations of the lubricant and the additive.

In the spin coating method, a mixture of the lubricant and the additive or a solution containing the lubricant and the additive is dripped into the inner circumferential portion of the rotating disk. In this case, the lubricant is centrifugally spread from the inner circumferential region toward the outer circumferential region so as to achieve a uniform coating. It is possible to control the thickness of the lubricant film by variously changing the lubricant concentration and the disk rotating speed.

In each of the methods described above, the lubricant and the additive are coated simultaneously. Alternatively, it is also possible to perform the coating of the lubricant and the additive separately so as to form a laminate structure.

It is preferred for the lubricant coating solution used for coating the protective layer with the lubricant to have a viscosity falling within a range of between 10 and 30,000 cSt. If the viscosity is lower than 10 cSt, a so-called “spin-off” phenomenon, in which the lubricant is moved outward by the rotation of the disk, is likely to take place. On the other hand, if the viscosity exceeds 30,000 cSt, the lubricant pushed aside in the position where the magnetic head has passed tends to fail to be brought back to the original position. It is more preferable for the viscosity of the lubricant coating solution to fall within a range of between 30 and 10,000 cSt.

It is preferable for the lubricating layer to have a thickness falling within a range of between 3 and 50 Å. If the thickness is less than 3 Å, the lubricant fails to produce its effect sufficiently, with the result that the protective layer of the magnetic film and the magnetic head tend to be abraded. On the other hand, if the thickness exceeds 50 Å, the adsorption force between the magnetic head and the magnetic disk is rendered excessively large so as to give a detrimental effect to the positioning of the magnetic head.

The materials forming the recording layer include, for example, a metal such as Fe, Co, Ni, an oxide thereof, Co-Ni, Co-Pt, Fe-Ni, Co-Cr, Co-Cr-Ta, Co-Cr-Pt, B-Co-C-Pt, Co-Pt-Ta, Co-Ni-Pt, Co-Cr-Pt-Si-, Co-Cr-Pt-Ta, Co-Cr-Ni-Pt-Ta, Co-Cr-Pt-Ta-Zr, Co-Cr-Nb-Pt-Ta-Co-Cr-Pt-O and Co-Pt-O.

In order to improve the flatness and to prevent corrosion of the magnetic layer, the materials suitable for forming the underlying layer include, for example, Ni-P, Ti, silicon, anodized aluminum, Cr, Cr-Ti, Cr-V, Cr-Si, Cr-Ag-Ta, Cr-W, Ru, and Cr-Ru. It should be noted, however, that it is not absolutely necessary to form the underlying layer. In other words, the underlying layer is formed optionally.

The recording layer and the underlying layer can be formed by, for example, a coating method, a plating method, a vapor deposition, a CVD and an IBD (Iron Beam Deposition) in addition to the sputtering method.

The protective layer can be formed by, for example, a diamond-like carbon, a hydrogenated carbon, a nitrogen-added carbon, a fluorine-added carbon, silica, zirconia and silicon nitride. In view of the chemical stability and the affinity with the lubricant, it is particularly desirable to use a diamond-like carbon, a hydrogenated carbon and a nitrogen-added carbon form forming the protective layer. Also, the protective layer can be formed by, for example, a vapor deposition, a sputtering method, a CVD, and an IBD method. Particularly, it is desirable to employ the CVD and the IBD because the protective film can be formed dense.

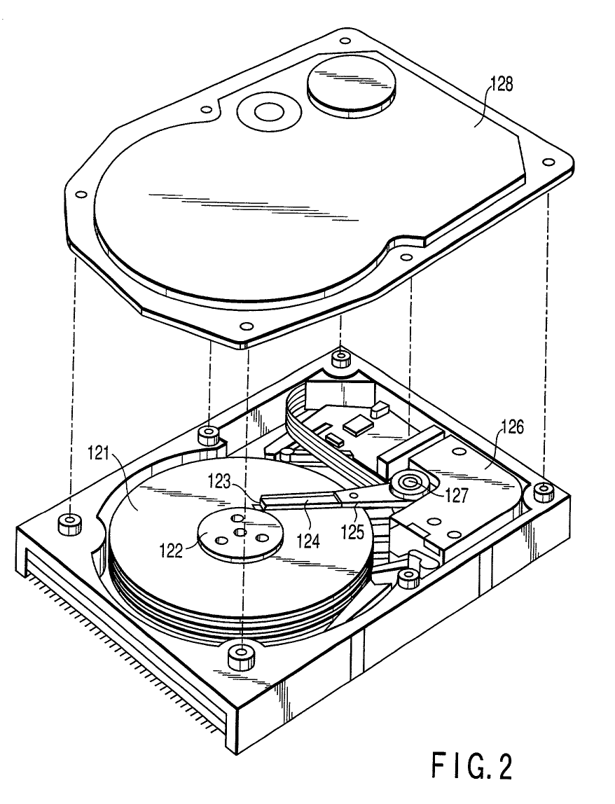

FIG. 2 is an oblique view, partly broken away, exemplifying a magnetic recording-reproducing apparatus of the present invention. As shown in the drawing, the magnetic recording-reproducing apparatus of the present invention comprises a rigid magnetic disk 121 for recording information. The magnetic disk 121 is mounted to a spindle 122 and is rotated at a predetermined angular speed by a spindle motor (not shown). A slider 123 supporting a magnetic head, which gains access to the magnetic disk 121 for recording-reproducing information is mounted to the tip of a suspension 124 consisting of a thin plate-like leaf spring. The suspension 124 is connected to one edge portion of an arm 125 having, for example, a bobbin portion for holding a driving coil (not shown).

A voice coil motor 126, which is a kind of a linear motor, is mounted to the other edge portion of the arm 125. The voice coil motor 126 comprises a driving coil (not shown) wound about the bobbin portion of the arm 125 and a magnetic circuit consisting of a permanent magnet arranged to have the driving coil held therein and a counter yoke.

The arm 125 is held by ball bearings (not shown) arranged in upper and lower portions of a stationary shaft 127 and is rotated and swung by the voice coil motor 126. To be more specific, the position of the slider 123 on the magnetic disk 121 is controlled by the voice coil motor 126. Incidentally, a reference numeral 128 shown in FIG. 2 represents a lid.

### EXAMPLES

### Example 1

Prepared was a disk having a construction equal to that shown in FIG. 1, except that a lubricating layer was not formed on the upper surface of the disk. The disk was prepared by using, for example, a glass substrate having a diameter of 65 mm.

The underlying layer was formed by sputtering Cr in a thickness of 15 nm. On the other hand, the magnetic layer was prepared by sputtering Co, Cr, Pt, and Ta in order in each thickness of 20 nm.

The protective layer was prepared by forming a DLC (diamond-like carbon) film in a thickness of 5 nm by a CVD method.

A lubricating layer coating solution having a viscosity of 80 cSt was prepared by adding to a solvent a mixture consisting of 99 parts by weight of Fomblin Zdol having a chemical formula (2) given previously and 1 part by weight of 1,3,5-trimethyl-2,4,6-tris (3,5-di-t-butyl-4-hydroxy benzyl) benzene having a chemical formula (3) given previously.

The surface of the disk was coated with the lubricating layer coating solution thus obtained by a dip coating method so as to form a lubricating layer and, thus, to obtain a magnetic disk.

The thickness of the lubricating layer thus formed, which was obtained by the calculation of the ratio of the C-C bond to the C-F bond of Cls in an X-ray photoelectron spectroscopy, i.e., XPS, was found to be 10 Å.

The magnetic disk was mounted to a magnetic recording-reproducing apparatus of the construction similar to that shown in FIG. 2, and the magnetic head was brought into contact with the surface of the magnetic disk such that the contact force between the magnetic head and the magnetic disk was 50 mgf. Under this condition, the angular speed of the magnetic disk was set at 4200 rpm.

Under the conditions described above, a continuous sliding test was continued for 2 weeks, and the magnetic disk after the test was observed by using an OSA (Optical Surface Analyzer manufactured by Candela Inc.).

In the OSA, the magnetic disk is irradiated with a laser beam and the intensity of the reflected light is measured. It is possible to obtain the mapping on the entire surface of the magnetic disk by measuring the reflected light intensity while rotating the magnetic disk and while moving the optical system in the radial direction of the magnetic disk.

Used in the OSA manufactured by Candela Inc. was a special polarized light called Q-polarized light, in which a P wave and an S wave are combined. There are a mode (Q phase) utilizing the phase difference between the P wave and the S wave in the Q-polarized light, the P component (Pq) of the Q-polarized light, and the S component (Sq) of the Q-polarized light. It is possible to examine the change in the surface of the magnetic disk on the basis of the change in the reflectivity. As a result of the measurement, no change was recognized in the sliding portion.

### Example 2

A magnetic disk was prepared as in Example 1, except that 2-mercaptomethyl benzimidazole was used in place of 1,3,5-trimethyl-2,4,6-tris (3,5-di-t-butyl-4-hydroxybenzyl) benzene. A continuous sliding test was applied to the resultant magnetic disk for 2 weeks, followed by observing the magnetic disk with an OSA. No change was recognized in the sliding portion.

### Example 3

A magnetic disk was prepared as in Example 1, except that prepared was a solution having a viscosity of 200 cSt by adding to a solvent a mixture consisting of 98 parts by weight of maleic anhydride denatured polybutene having a chemical structure (1) given previously, which was used in place of Fomblin Zdol used in Example 1, and 2 parts by weight of n-octadecyl-3-(4′-hydroxy-3′,5′-di-t-butyl phenyl) propionate, which was used in place of 1,3,5-trimethyl-2,4,6-tris (3,5-di-t-butyl-4-hydroxy benzyl) benzene used in Example 1, and that the lubricating layer was formed in a thickness of 15 Å. A continuous sliding test was applied to the resultant magnetic disk for 2 weeks, followed by observing the magnetic disk with an OSA. No change was recognized in the sliding portion.

### Comparative Example 1

A magnetic disk was prepared as in Example 1, except that Fomblin Zdol alone was used as the lubricant, a lubricating layer was formed in a thickness of 10 nm without using an additive. A continuous sliding test was applied to the resultant magnetic disk for 2 weeks, followed by observing the magnetic disk with an OSA.

A change, which was considered to be a degradation of the lubricant, was found in the sliding portion. Also, when it comes to the result of the observation with the OSA, the reflectance was increased in Pq and decreased in Sq. This is a change that is observed when the lubricant was agglomerated or degraded. Since the state remained unchanged in spite of the lapse of time, it is considered reasonable to understand that the lubricant was degraded. When it comes to Pq, the difference in reflectance (Δreflectance) between the sliding portion and the non-sliding portion was 0.13%.

### Comparative Example 2

A magnetic disk was prepared as in Example 1, except that 100 parts by weight of Fomblin Zdol and cyclotriphosphazen (X-1P) having a chemical structure (5) given below were used in place of the lubricant used in the Examples of the present invention, and that the lubricating layer was formed by a coating method in a thickness of 10 nm.

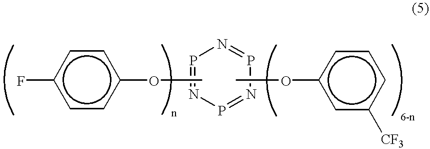

A continuous sliding test was applied to the resultant magnetic disk for 2 weeks as in Example 1, followed by observing the magnetic disk with an OSA.

A change, which was considered to be a degradation of the lubricant, was found in the sliding portion as in Comparative Example 1. The value of Δreflectance was found to be 0.1%.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording media comprising;
a substrate, and
a laminated layer formed on said substrate, having a magnetic layer, and a lubricating layer, said lubricating layer having a lubricant and at least one antioxidant of a phenolic antioxidant and an amine-based antioxidant.

2. The magnetic recording media according to claim 1, wherein said lubricant includes at least one of a fluorine-based lubricant and a maleic anhydride denatured polybutene.

3. The magnetic recording media according to claim 2, wherein said fluorine-containing lubricant includes at least one material selected from the group consisting of Fomblin Z, Fomblin Y, Krytox, Demnum and derivatives thereof having a denatured terminal group.

4. The magnetic recording media according to claim 1, wherein a content of said antioxidant in said lubricating layer is 0.05 to 10% by weight.

5. The magnetic recording media according to claim 1, wherein said protective layer contains at least one material selected from the group consisting of a diamond-like carbon, a hydrogenated carbon, a nitrogen-added carbon, silica, zirconia and silicon nitride.

6. The magnetic recording media according to claim 1, further comprising a protective layer between said magnetic layer and said lubricant layer.

7. A magnetic recording-reproducing apparatus, comprising:
a magnetic recording media comprising a substrate and a laminate layer formed on said substrate, including a magnetic layer, and a lubricating layer, said lubricating layer having a lubricant and at least one antioxidant of a phenolic antioxidant and an amine-based antioxidant;
a driving mechanism for supporting and rotating said magnetic recording media;
a magnetic head including an element to record information in said magnetic recording media and an element to reproduce the information recorded in the magnetic recording media; and
a carriage assembly supporting said magnetic head such that the supported magnetic head is movable relative to said magnetic recording media.

8. The magnetic recording-reproducing apparatus according to claim 7, said lubricant contains at least one of a fluorine-based lubricant and a maleic anhydride denatured polybutene.

9. The magnetic recording-reproducing apparatus according to claim 7, wherein said fluorine-containing lubricant includes at least one material selected from the group consisting of Fomblin Z, Fomblin Y, Krytox, Demnum and derivatives thereof having a modified terminal group.

10. The magnetic recording-reproducing apparatus according to claim 7, wherein a content of said antioxidant in said lubricating layer is 0.05 to 10% by weight.

11. The magnetic recording-reproducing apparatus contains claim 7, wherein said protective layer contains at least one material selected from the group consisting of a diamond-like carbon, a hydrogenated carbon, a nitrogen-added carbon, silica, zirconia and silicon nitride.

12. The magnetic recording-reproducing apparatus according to claim 7, which is a contact recording type, in which the magnetic head is in contact with the magnetic disk in recording-reproducing information, or a contact-start-stop type, in which the magnetic head floats in the recording-reproducing stage and the magnetic head is in contact with the magnetic disk when the magnetic disk is not rotated.

13. The magnetic recording-reproducing media according to claim 7, further comprising a protective layer between said magnetic layer and said lubricant layer.
